(19) United States
(12) Patent Application Publication
(10) Pub. No.: US 2007/0001980 A1
(43) Pub. Date: Jan. 4, 2007

(54) Timing controllers for display devices, display devices and methods of controlling the same

(75) Inventor: Cheon-Ho Bae, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/474,543

(22) Filed: Jun. 26, 2006

(30) Foreign Application Priority Data
Jun. 30, 2005 (KR) 10-2005-0058670

(51) Int. Cl. G09G 3/36

(52) U.S. Cl. 345/98

(57) ABSTRACT

Timing controllers, display devices and methods of operating the same are provided. The timing controller of a display device includes a timing generator, a frame counter unit and an initial operation control unit. The timing generator generates a source driver control signal and a gate driver control signal for controlling a source driver and a gate driver, respectively, based on a synchronization signal input from an external device. The frame counter unit operates a frame counter based on the synchronization signal. The initial operation control unit controls the gate driver control signal based on an output of the frame counter unit in order for an output of the gate driver to be disabled during a period of time after the display device is powered-on.

### CLAIM OF PRIORITY

This application is related to and claims priority from Korean Patent Application No. No. 2005-58670 filed on Jun. 30, 2005, in the Korean Intellectual Property Office, the disclosure of which is hereby incorporated herein by reference as if set forth in its entirety.

### FIELD OF THE INVENTION

The present invention relates to display devices and related methods, and more particularly, to display devices including timing controllers and related methods.

### BACKGROUND OF THE INVENTION

Recently, the demand for smaller more compact electronic devices has increased. In order to satisfy such demands, various flat panel display devices have been developed and have become widespread in lieu of conventional cathode ray tube (CRT) displays.

A liquid crystal display (LCD) device is one type of flat panel display device. Still or moving pictures may be displayed by changing a liquid crystal molecule arrangement of a liquid crystal material having a dielectric anisotropy injected between an alignment layer of an upper substrate and an alignment layer of a lower substrate, and adjusting a ratio of light transmission through the changed liquid crystal molecule arrangement. In the alignment layer of the upper substrate, common electrodes and color filters are formed, and in the alignment layer of the lower substrate, a thin-film transistor (TFT) and pixel electrodes are formed. A liquid crystal molecule arrangement may be changed after applying a power voltage to the pixel electrodes and common electrodes in order to form electronic fields.

LCD devices may be thin, light weight, have a low drive voltage and a low power consumption. Additionally, because LCDs device may have a display quality close to that of CRTs, LCD devices may be used for various devices, such as mobile communication devices, monitors, notebooks and the like. In particular, LCD devices are often used for display means in the mobile terminals, such as mobile phones.

Referring now to FIG. 1, a block diagram illustrating a conventional liquid crystal display (LCD) device will be discussed. As illustrated in FIG. 1, the conventional LCD device 10 may include an LCD panel 11, a gate driver 13, a source driver 12, a gamma voltage generator 16 and a timing controller 14. The LCD panel 11 includes a substrate on which a pixel pattern is formed. The substrate includes a plurality of gate lines and a plurality of data lines that intersect with each other. A plurality of pixels are formed at each of the intersection points of the gate lines and the data lines, and an image display operation of the pixels is controlled by one of the switching elements, the thin film transistors (TFT).

The gate driver 13 is configured to sequentially select each of the gate lines formed on the LCD panel 11 in sequence according to the horizontal scanning time period, and the TFT corresponding to each of the pixels coupled to the selected gate line changes a state of the corresponding pixel to a displayable state.

The source driver 12 is configured to receive image data and a gamma voltage to select the gamma voltage corresponding to the image data assigned to each of the data lines, and the selected gamma voltage is applied to the corresponding data line in order to display the image data on the pixel coupled to the selected gate line. The gamma voltage provided to the source driver 12 may be generated by the gamma voltage generator 16.

The timing controller 14 is configured to receive image data RGB, a synchronization signal SYNC and a clock signal CLK from an external host system 20, convert a format of the image data RGB to a format required for the source driver 12, and generate a control signal for controlling the source driver 12 and the gate driver 13 based on the synchronization signal SYNC and the clock signal CLK.

In conventional LCD devices, an image distortion may occur because the conventional LCD device may experience an unstable state temporarily at a time when a power voltage begins to be provided. For example, the time when the power voltage is provided may be a power-on time or a wake-up time.

The image distortion that may occur due to the unstable state of the display device may be caused by an external factor and an internal factor. The external factor may include noise mixed in a video source provided from an external source, or garbage data received from an external memory device. The internal factor may include a mismatch between initial periods of time required for respective devices included in the LCD device to perform normal operations.

Although the distorted image is displayed during a short period of time, the distorted image may be visible to the naked eye. Thus, there may be cases where users may regard the LCD device as defective.

In conventional LCD devices, when a power voltage is applied, a backlight is temporarily powered-off by an external processor so that users may not recognize the image distortion, or the power voltage and data provided to the LCD panel are controlled by the external processor.

However, conventional LCD devices typically must have a separate external control signal, because the initialization process of units included in the LCD devices need to be controlled by the external processor, such as a main control unit (MCU).

Additionally, there is typically no consideration as to whether or not the LCD device is in a stable state, in which the LCD device is synchronized with a video signal provided from an external source, because the conventional LCD device simply delays an initial display process by as much as a time set by the external processor.

Therefore, the conventional LCD device may not effectively solve the problem of the image distortion in an initial drive stage, i.e., a time point at which the power voltage is applied.

### SUMMARY OF THE INVENTION

Some embodiments of the present invention provide timing controllers for liquid crystal display (LCD) devices, display devices and methods of operating the same. The timing controller may include a timing generator configured to generate a source driver control signal and a gate driver control signal to control a source driver and a gate driver, respectively, based on a synchronization signal input from an external device. A frame counter unit is configured to operate a frame counter based on the synchronization signal. An initial operation control unit is configured to control the gate driver control signal based on an output of the frame counter to disable an output of the gate driver for a period of time after the LCD device is powered-on.

In further embodiments of the present invention, the period of time after the LCD device is powered on may be about two frames. The period of time after the LCD is powered on may be user customizable.

In still further embodiments of the present invention, the synchronization signal input from the external device may include a vertical synchronization signal, a horizontal synchronization signal, a data enable signal and/or a master clock signal. The frame counter unit may generate an internal vertical synchronization signal based on the data enable signal input from the external device. The internal vertical synchronization signal may be generated when an input signal does not exist in a low level range of the data enable signal after a specified period of time. The frame counter unit may operate the frame counter based on the generated internal vertical synchronization signal. The frame counter may not operate when the data enable signal is unstable.

In some embodiments of the present invention, the source driver control signal may include a horizontal start pulse, a data latch signal and/or a polarity control signal. Furthermore, the source driver control signal may be output to the source driver by a control signal of the initial operation control unit.

In further embodiments of the present invention, the gate driver control signal may include a vertical start pulse and/or a vertical clock signal. The gate driver control signal may include a gate driver output enable signal that controls an output of the gate driver. The initial operation control unit may disable the gate driver output enable signal during the period of time after the LCD device is powered on.

In still further embodiments of the present invention, a control signal output unit may be configured to output the source driver control signal and the gate driver control signal generated by the timing generator based an output permission signal provided from the initial operation control unit. The control signal output unit may include a plurality of logic gates that perform a logical AND operation of one of the output permission signals provided from the initial operation control unit and one of the source driver control signal and the gate driver control signal.

In some embodiments of the present invention, a data processing unit may be configured to receive red, green, blue (RGB) data from an external device and convert the RGB data into a data format read by the source driver. A data output unit may be configured to output the RGB data converted by the data processing unit to the source driver, under a control of the initial operation control unit. The initial operation control unit may control the data output unit such that the data output unit outputs the converted RGB data to the source driver, as the gate driver is enabled and a second period of time elapses thereafter. The second period of time may be about a single frame. The data output unit may include a multiplexer having an input terminal to which the converted RGB data output from the data processing unit and a low level data for displaying black data is input, and a selection terminal to which a selection signal from the initial operation control unit is input.

Although timing controllers are specifically discussed above, embodiments of the present invention also include display devices including the timing controllers and methods of operating the same.

### BRIEF DESCRIPTION OF THE DRAWINGS

FIG. 1 is a block diagram illustrating a conventional liquid crystal display (LCD) device.

FIG. 2 is a block diagram illustrating a liquid crystal display (LCD) device having a timing controller according to some embodiments of the present invention.

FIG. 3 is a flowchart illustrating operations for controlling an initial operation of the LCD device using the timing controller shown in FIG. 2 according to some embodiments of the present invention.

FIG. 4 is a timing diagram illustrating signals associated with operations of controlling an initial operation of the LCD device using the timing controller in FIG. 2 according to some embodiments of the present invention.

FIG. 5 is a timing diagram illustrating a generating process of an internal vertical synchronization signal according to some embodiments of the present invention.

FIGS. 6 and 7 are timing diagrams illustrating operations of a frame counter based on the internal vertical synchronization signal in FIG. 5 according to some embodiments of the present invention.

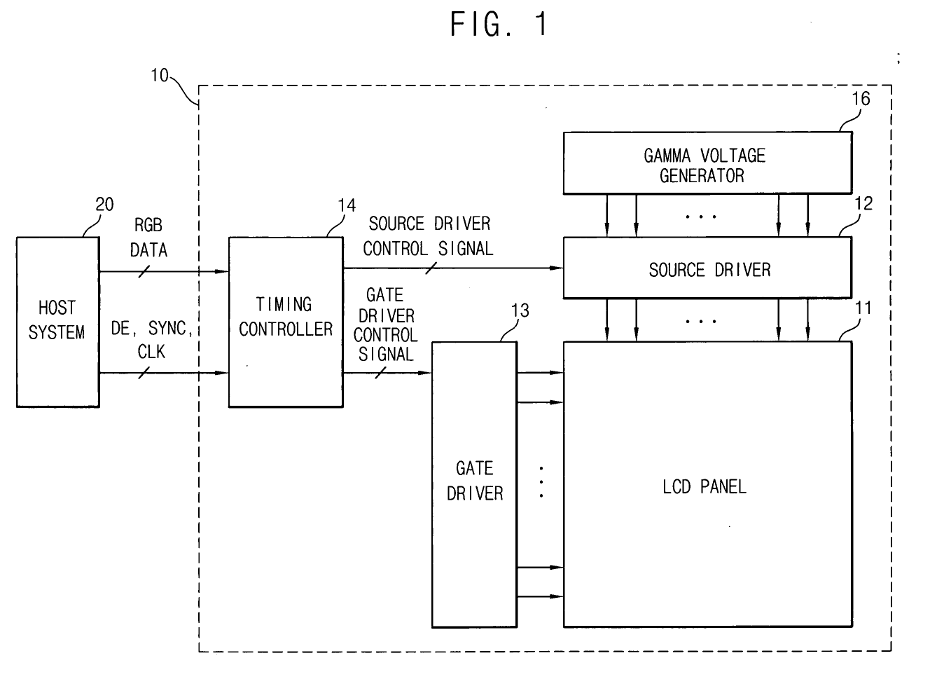

### DETAILED DESCRIPTION OF EMBODIMENTS OF THE PRESENT INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items. Like numbers refer to like elements throughout.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in the Figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that the some embodiments of the present invention are described herein with respect to flowchart diagrams. It should also be noted that, in some alternative implementations, the operations noted in the flowcharts may occur out of the order noted in the figures. For example, two blocks shown in succession may, in fact, be executed substantially concurrently, or the blocks may sometimes be executed in the reverse order.

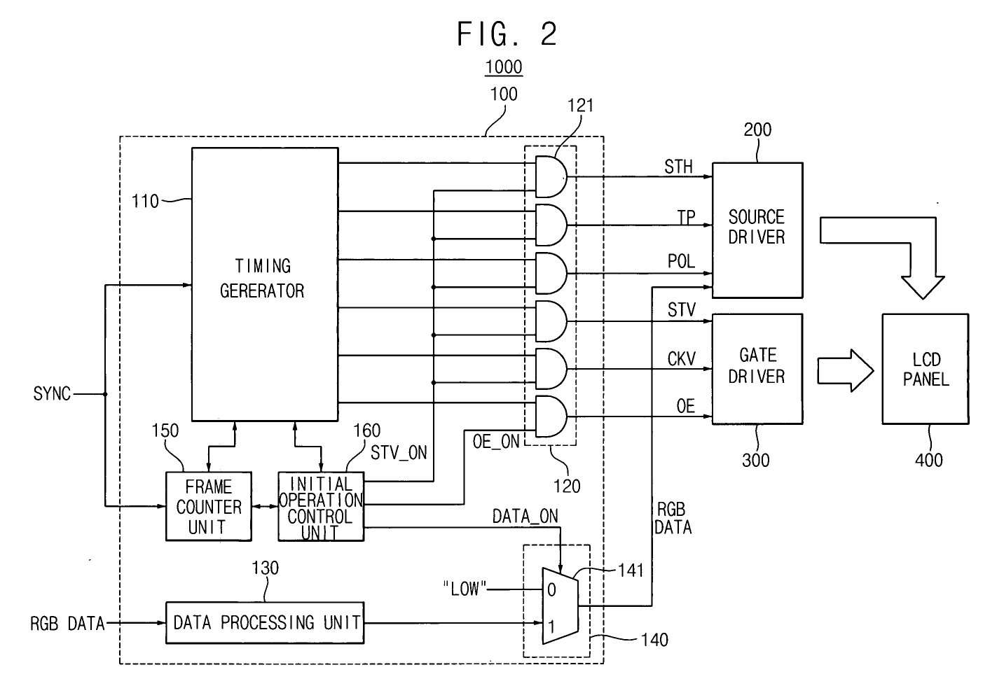

Referring first to FIG. 2, a block diagram illustrating a liquid crystal display (LCD) device having a timing controller according to some embodiments of the present invention will be discussed. As illustrated in FIG. 2, an LCD device 1000 according to some embodiments of the present invention includes a timing controller 100, a source driver 200, a gate driver 300 and an LCD panel 400. The timing controller 100 includes a timing generator 110, a control signal output unit 120, a data processing unit 130, a data output unit 140, a frame counter unit 150 and an initial operation control unit 160.

As illustrated, the timing controller 100 is coupled to the source driver 200 and the gate driver 300 in the LCD device 1000. The timing generator 110 generates a plurality of control signals for controlling the source driver 200 and the gate driver 300 based on synchronization signals SYNC input from an external graphic source, that is, a vertical synchronization signal VSYNC, a horizontal synchronization signal HSYNC, a data enable signal DE and a master clock signal MCK.

A source driver control signal for controlling the source driver 200 may include, for example, a horizontal start pulse STH, a data latch signal TP and a polarity control signal POL. Additionally, a gate driver control signal for controlling the gate driver 300 may include, for example, a vertical start pulse STV, a vertical clock signal CKV and a gate driver output enable signal OE.

The control signal output unit 120 outputs the control signals generated from the timing generator 110, that is, the source driver control signal and the gate driver control signal, to the source driver 200 and the gate driver 300, respectively, in response to an output permission signal generated from the initial operation control unit 160.

In some embodiments of the present invention, the control signal output unit 120 may include a plurality of AND gates 121 that receive the respective control signals generated from the timing generator 110, and the output permission signal generated from the initial operation control unit 160, and perform an AND operation to output the performed result. Although the control signal output unit 120 is discussed herein as including AND gates, it will be understood that embodiments of the present invention are not limited to this configuration. For example, AND gate equivalents may be used without departing from the scope of the present invention.

The output permission signal may include an OE output permission signal OE_ON that controls an output of the gate driver output enable signal OE, and a control signal output permission signal STV_ON that controls an output of the source driver control signals and the gate driver control signals except for the gate driver output enable signal OE.

The gate driver output enable signal OE is a signal for masking an output of the gate driver 300. Namely, when the gate driver output enable signal OE corresponds to a logic ‘high’, the output of the gate driver 300 is masked, and when the gate driver output enable signal OE corresponds to a logic ‘low’, the output of the gate driver 300 is output normally. Details of the gate driver output enable signal OE will be discussed further herein.

The data processing unit 130 receives red, green, blue (RGB) data from the external graphic source to output, to the data output unit 140, a result that is level-shifted to a suitable format for the source driver 200, namely, a result that converts a level of the RGB data.

The data output unit 140 selects one of the RGB data output from the data processing unit 130 or a low level signal for displaying black data to the LCD panel 400 based on a data output permission signal DATA_ON output from the initial operation control unit 160. The selected signal is provided to the source driver 200.

The data output unit 140 may include a multiplexer 141 where the RGB data output from the data processing unit 130 and the low level signal for displaying the black data is input through an input terminal of the data output unit 140, and the data output permission signal DATA_ON output from the initial operation control unit is applied through a selection terminal of the data output unit 140.

The frame counter unit 150 performs a frame counting operation based on the synchronization signal SYNC input from the external graphic source. Namely, based on the data enable signal DE representing a data efficiency among the input synchronization signal SYNC, the frame counter unit 150 generates an internal vertical synchronization signal IVS. Using a rising edge or a falling edge of the internal vertical synchronization signal IVS, the frame counter unit 150 performs the frame counting. A line counter that is used to perform the frame counting operation is generated by the timing generator 110.

The initial operation control unit 160 controls an initial operation of the LCD device 1000 when the LCD device 1000 is powered on, based on an output of the frame counter unit 150. The initial operation control unit 160 disables an output of the gate driver 300 for a time period corresponding to about two frames according to frame information. In particular, the output of the gate driver 300 may be disabled for a time period two frames plus α, wherein the value a may be set by a user. In order to disable the output of the gate driver 300, the initial operation control unit 160 uses the OE output permission signal OE_ON that controls the output of the gate driver output enable signal OE for performing a mask operation on the output of the gate driver 300.

Furthermore, the initial operation control unit 160 controls the data output unit 140 to output the black data, and controls the data output unit 140 to output the RGB data after about one more frame elapses from a time period corresponding to initial two frames plus α.

The initial operation control unit 160 uses the data output permission signal DATA_ON applied to the data output unit 140. In particular, before the time of about one more frame elapses from the time of about two frames plus α, the initial operation control unit 160 outputs the data output permission signal DATA_ON having a logic low level, so the data output unit 140 selects the low level signal to output the low level signal to the source driver 200.

After about one more frame elapses from the time period corresponding to two frames plus a, the initial operation control unit 160 outputs the data output permission signal DATA_ON having a logic high level so the data output unit 140 selects the RGB data output from the data processing unit 130 to output the RGB data to the source driver 200.

Therefore, after a time period of about two frames plus a from a time when a power voltage is applied to the gate driver 200 of the LCD device 1000, normal data is output to the LCD panel 400. After a time period of about one more frame, the LCD panel 400 displays a normal image. Therefore, any image distortion that may occur at an initial operation stage may be reduced.

The gate driver control signals except for the source driver control signal and the gate driver output enable signal OE output from the timing generator 110 are output normally from an initial stage of a power-on by the initial operation control unit 160. The source driver 200 and the gate driver 300 perform a normal operation under a control of the timing generator 110 even during a time when the LCD panel 400 does not display an image. This is because the timing generator 110 provides the source driver 200 and the gate driver 300 a time for warming-up.

As discussed above, although the LCD device does not have an external separate signal, a configuration of the timing controller 100 that may reduce the image distortion that may occur during an initial operation stage is described. The method for controlling the LCD device 1000 during an initial operation based on the configuration of the timing controller 100 will be discussed below.

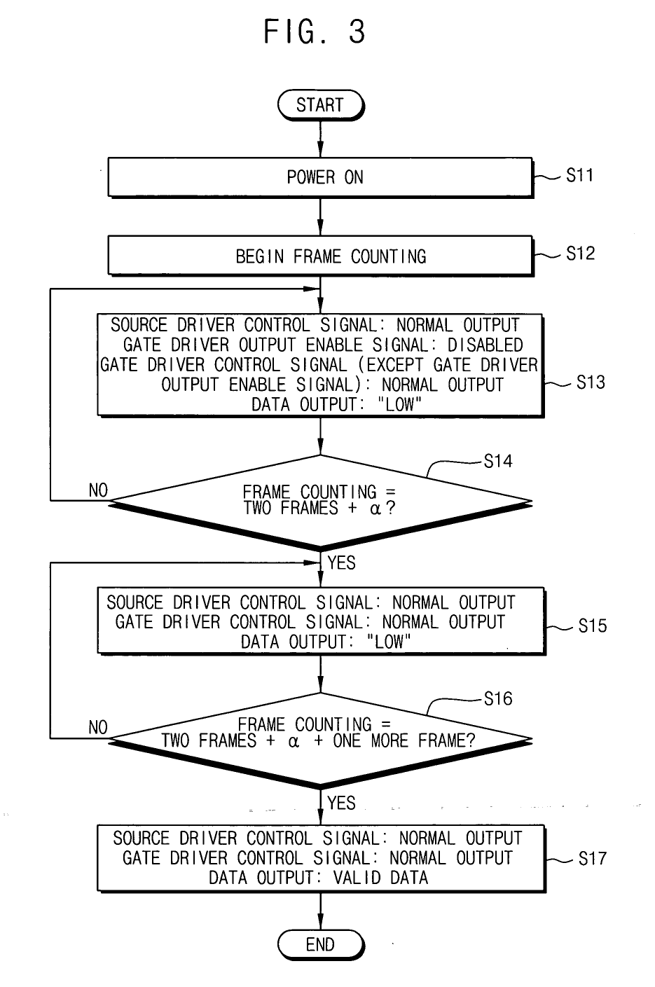

Referring now to FIG. 3, a flowchart illustrating steps in the operation for controlling an initial operation of the LCD device 1000 using the timing controller 100 shown in FIG. 2 according to some embodiments of the present invention will be discussed. As illustrated in FIG. 3, operations being at block S 11 by powering on the device. The timing controller 100 operates the frame counter of the frame counter unit 150 to perform frame counting (block S12).

The timing controller 100 performs a normal output of the source driver control signal generated by a synchronization signal input from an external device, disables the gate driver output enable signal OE, and performs a normal output of the gate driver control signals except for the gate driver output enable signal OE. Concurrently, the timing controller 100 outputs a low level signal to the source driver 200 in order to force the LCD device 1000 to display the black data (block S13).

Therefore, normal operations of the source driver 200 and the gate driver 300 are performed by the source driver control signal and the gate driver signal (block S13). However, an output of the gate driver 300 is masked because the gate driver output enable signal OE is disabled. During the time when the output of the gate driver 300 is masked, the source driver 200 and the gate driver 300 may perform a warming-up procedure.

The timing controller 100 refers to a frame counter value to determine whether the frame counter value becomes equal to ‘two frames plus α’ (block S14). In particular, the timing controller 100 determines that a time period corresponding to the ‘two frames plus α’ elapses from an initial operation time of the frame counter. The value ‘α’ may be set by a user. In some embodiments of the present invention, the value ‘α’ may be a value ‘0’.

When the frame counter value is equal to ‘two frames plus α’, the timing controller 100 enables the gate driver output enable signal OE (block S14). Therefore, the source driver 200 and the gate driver 300 operate normally, because both the source driver control signal and the gate driver control signal are output normally. Meanwhile, the timing controller 100 continuously outputs an invalid low level signal to the source driver 200 to force the LCD device to display the black data (block S15).

The timing controller 100 determines whether the frame counter value is equal to ‘two frames plus α plus one frame’ or not (block S16). In particular, the timing controller 100 determines whether a time of about one frame elapses after a time period corresponding to ‘two frames plus α’ from an initial operation of the frame counter.

When the frame counter value is equal to ‘two frames plus α plus one frame’, the timing controller 100 outputs valid data to the source driver 200. Therefore, a normal image is displayed in the LCD panel 400 (block S17). In some embodiments of the present invention, a normal image refers to an image having a relatively reduced amount of distortion.

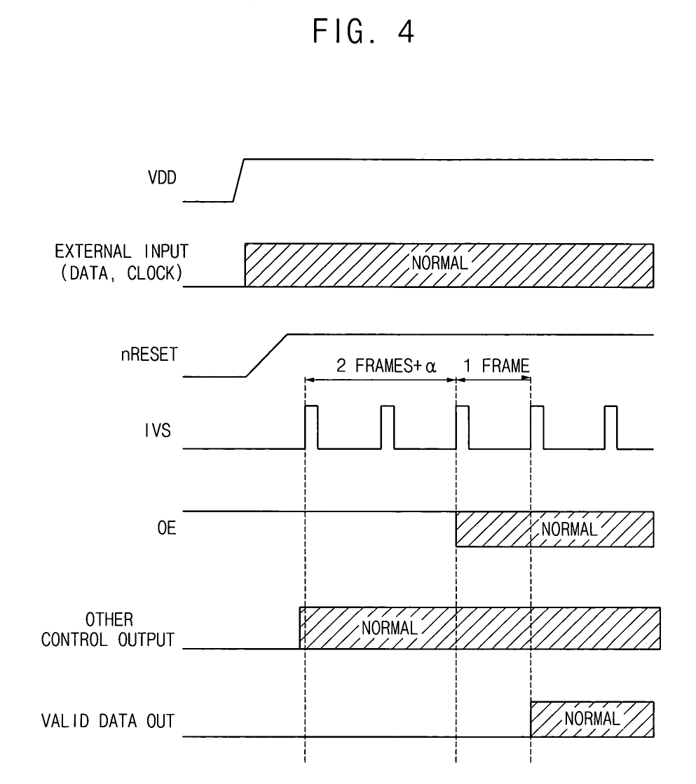

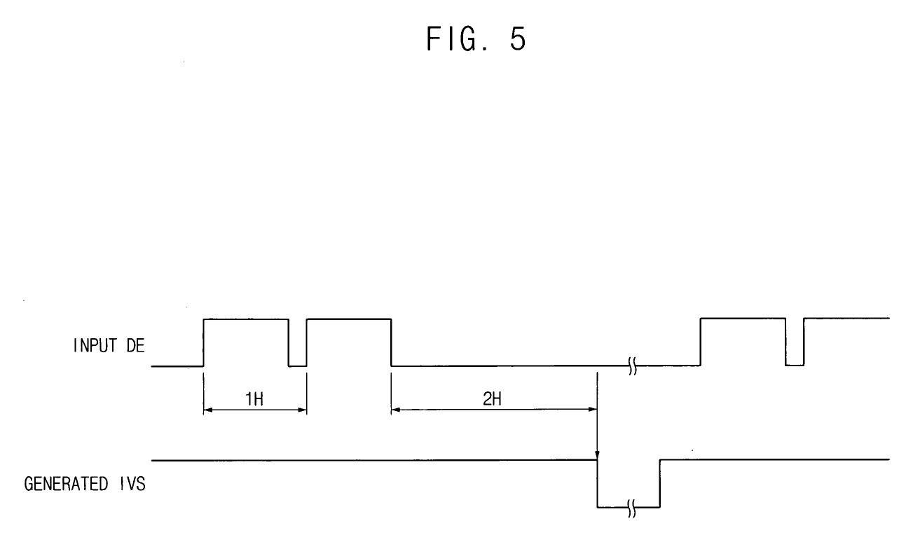

Referring now to FIG. 4, a timing diagram illustrating signals associated with a operations of controlling an initial operation of the LCD device 1000 using the timing controller 100 in FIG. 2 according to some embodiments of the present invention will be discussed. As illustrated in FIG. 4, when a power voltage VDD is applied, external inputs such as data and clocks are input normally. The internal vertical synchronization signal IVS is generated based on the data enable signal DE representing a data efficiency, and the generation of the internal vertical synchronization signal IVS may be recognized by the vertical start pulse STV. The internal vertical synchronization signal IVS is a signal internally generated by the frame counter unit 150 of the timing controller 100 to operate frame counting. Further details of the internal vertical synchronization signal IVS will be described below with reference to FIGS. 5 through 7.

The gate driver output enable signal OE is disabled initially and then enabled after initial two frames elapse from a power-on. However, during the time periods when the gate driver output enable signal OE is disabled, the source driver control signals and the gate driver control signals except for the gate driver output enable signal OE, are output normally. Therefore, the source driver 200 and the gate driver 300 may obtain a time for an initial warming-up.

Furthermore, after about one more frames elapse from the about two initial frames, valid data is transmitted to the source driver 200 so that a normal image may be output. Before about one more frames elapse from the about initial two frames from an initial power-on, black data is output. Therefore, any image distortion that may occur in an initial operation time may be reduced.

Referring now to FIG. 5, a timing diagram illustrating a generating process of the internal vertical synchronization signal IVS according to some embodiments of the present invention will be discussed. As illustrated in FIG. 5, the internal vertical synchronization signal IVS is generated through the data enable signal DE input from external devices. When an input of the data enable signal DE does not exist during about two horizontal periods 2H, the frame counter unit 150 generates the internal vertical synchronization signal IVS based on a line counter operating in a range in which the data enable signal DE is a low level.

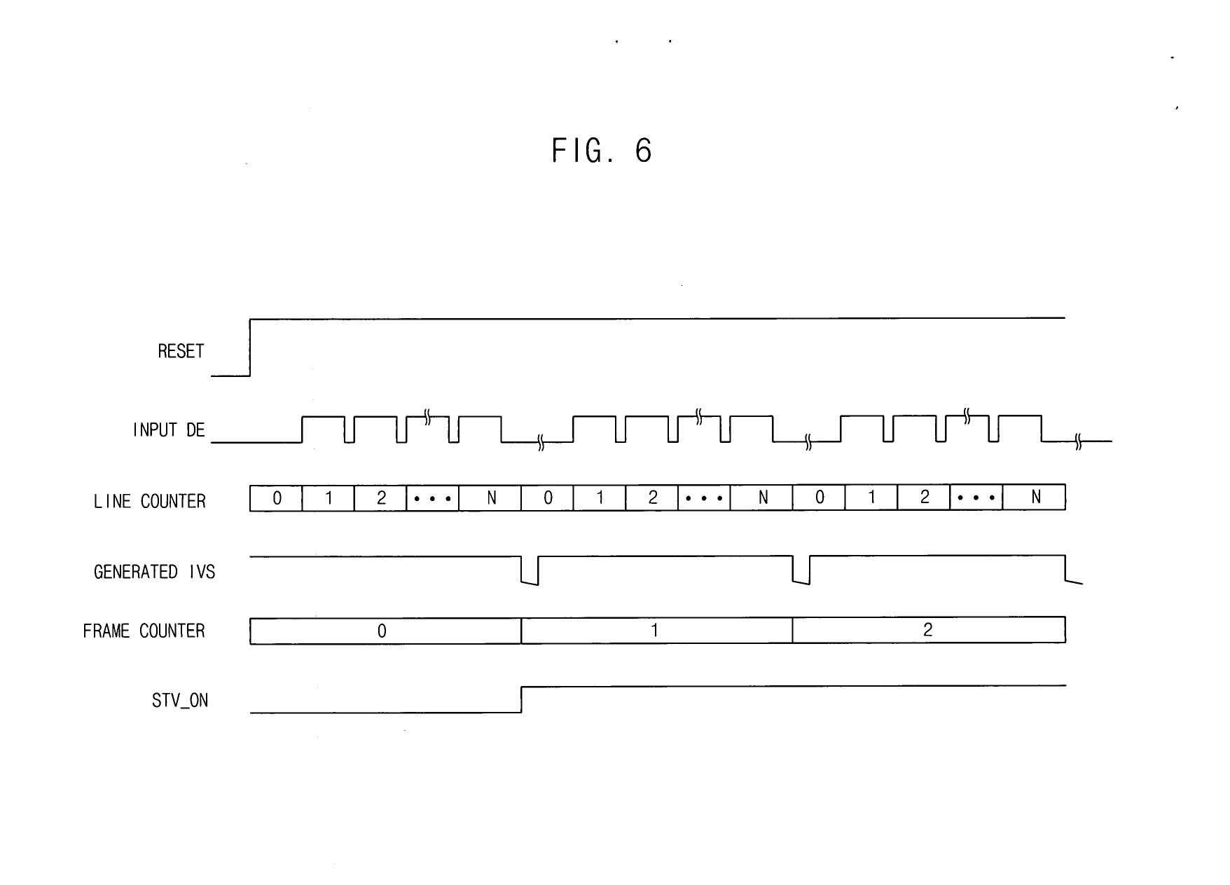

Referring now to FIG. 6, a timing diagram illustrating an operation of the frame counter in response to the internal vertical synchronization signal IVS in FIG. 5 will be discussed. As illustrated in FIG. 6, the line counter operates according to the data enable signal DE, and the internal vertical synchronization signal IVS is generated when a data input signal does not exist during the predetermined time. In some embodiments of the present invention, the predetermined time may correspond to about two horizontal periods 2H.

The frame counter operates in response to a falling edge of the generated internal vertical synchronization signal IVS. Furthermore, when the frame counter begins to operate, the control signal output permission signal STV_ON, which controls an output of the source driver control signals and the gate driver control signals except for the gate driver output enable signal OE, is output. In further embodiments of the present invention, the frame counter may be configured to operate in response to a rising edge of the internal vertical synchronization signal IVS. The data enable signal DE input from an external device may have noise therein. When the data enable signal DE has noise, the frame counter may not operate.

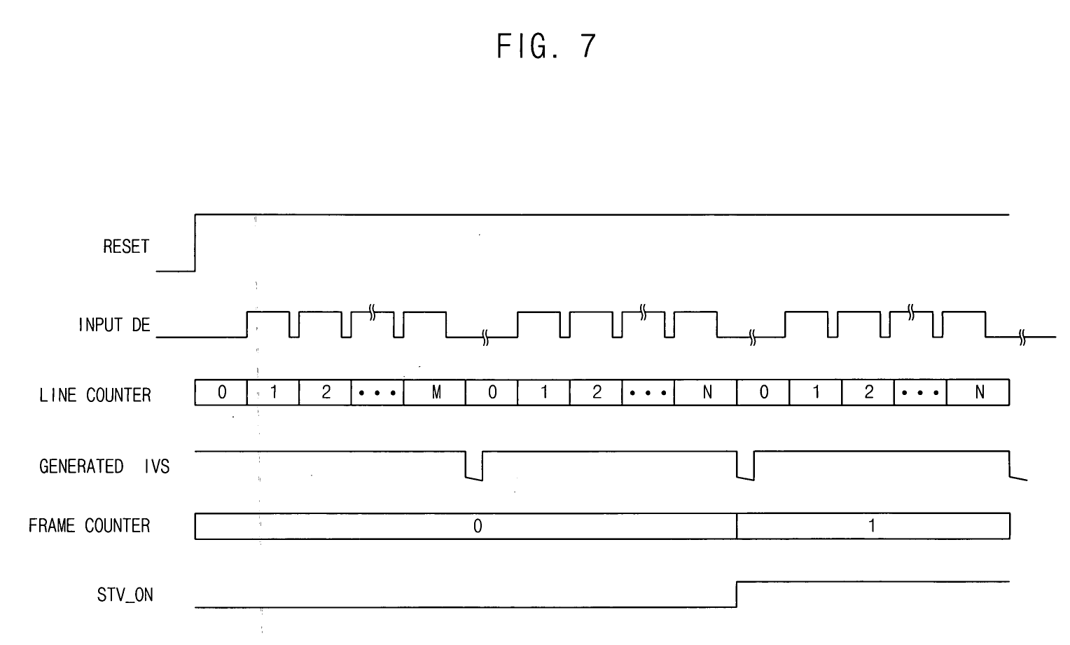

Referring now to FIG. 7, a timing diagram illustrating an operation of the frame counter by the internal vertical synchronization signal IVS in FIG. 5 where the data enable signal DE input from an external device is unstable according to some embodiments of the present invention will be discussed. As illustrated in FIG. 7, a first counting value of the data enable signal DE calculated by the line counter is not ‘N’ as shown in FIG. 6, but ‘M’. In particular, the data enable signal DE input from an external device is unstable.

Therefore, the frame counter may not operate even though the internal vertical synchronization signal IVS transitions into a falling edge. In particular, the frame counter refers to the line counter value, so the frame counter does not calculate unstable data input from the external device. Consequently, the line counter may initially recognize an unstable data input from the external device and adaptively delay the frame counter operation.

As briefly discussed above with respect to FIGS. 2 through 7, in display devices according to some embodiments of the present invention, the output of the gate driver is enabled after a predetermined number of frames elapse from an initial driving of the display device, and a predetermined time period later, a normal output operation of an image is performed. Therefore, any image distortion that may occur during an initial operation stage may be stably reduced without using a separate external control signal.

Exemplary embodiments of the present invention have been described with regard to logic signals logic high ‘H’, and logic low ‘L’. However, it will be understood that any suitable logic signal and/or voltage level may be used. For example, a binary signal ‘1’ or higher voltage level, for example, +5 volts, may correspond to a logic high signal, and a binary signal ‘0’ or lower voltage level, for example, 0 or −5 volts, may correspond to a logic low signal. It will further be understood that the logic signals and/or voltage levels as described herein are interchangeable, as desired.

Although exemplary embodiments of the present invention have been described with regard to specific logic gates and logic operations, it will be understood that any suitable logic gates and/or logic operations may be used interchangeably.

Furthermore, although exemplary embodiments of the present invention have been described with regard to specific example embodiments, it will be understood that variations and/or changes that may be made to, for example, the control signal output unit 120, the data output unit 140 or any other circuit, element, etc., of the example embodiments of the present invention, within the scope of the present invention.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A timing controller for an liquid crystal display (LCD) device, comprising:
a timing generator configured to generate a source driver control signal and a gate driver control signal to control a source driver and a gate driver, respectively, based on a synchronization signal input from an external device;
a frame counter unit configured to operate a frame counter based on the synchronization signal; and
an initial operation control unit configured to control the gate driver control signal based on an output of the frame counter to disable an output of the gate driver for a period of time after the LCD device is powered-on.

2. The timing controller of claim 1, wherein the period of time after the LCD device is powered on is about two frames.

3. The timing controller of claim 1, wherein the period of time after the LCD is powered on is user customizable.

4. The timing controller of claim 1, wherein the synchronization signal input from the external device comprises a vertical synchronization signal, a horizontal synchronization signal, a data enable signal and/or a master clock signal.

5. The timing controller of claim 4, wherein the frame counter unit generates an internal vertical synchronization signal based on the data enable signal input from the external device.

6. The timing controller of claim 5, wherein the internal vertical synchronization signal is generated when an input signal does not exist in a low level range of the data enable signal after a specified period of time.

7. The timing controller of claim 5, wherein the frame counter unit operates the frame counter based on the generated internal vertical synchronization signal.

8. The timing controller of claim 7, wherein the frame counter does not operate when the data enable signal is unstable.

9. The timing controller of claim 1, wherein the source driver control signal comprises a horizontal start pulse, a data latch signal and/or a polarity control signal, and wherein the source driver control signal is output to the source driver by a control signal of the initial operation control unit.

10. The timing controller of claim 1, wherein the gate driver control signal comprises a vertical start pulse and/or a vertical clock signal.

11. The timing controller of claim 1, wherein the gate driver control signal includes a gate driver output enable signal that controls an output of the gate driver.

12. The timing controller of claim 11, wherein the initial operation control unit disables the gate driver output enable signal during the period of time after the LCD device is powered on.

13. The timing controller of claim 1, further comprising:
a control signal output unit configured to output the source driver control signal and the gate driver control signal, respectively, generated by the timing generator, based an output permission signal provided from the initial operation control unit.

14. The timing controller of claim 13, wherein the control signal output unit includes a plurality of logic gates that perform a logical AND operation of one of the output permission signals provided from the initial operation control unit and one of the source driver control signal and the gate driver control signal.

15. The timing controller of claim 1, further comprising:
a data processing unit configured to receive red, green, blue (RGB) data from an external device and convert the RGB data into a data format read by the source driver; and
a data output unit configured to output the RGB data converted by the data processing unit to the source driver, under a control of the initial operation control unit.

16. The timing controller of claim 15, wherein the initial operation control unit controls the data output unit such that the data output unit outputs the converted RGB data to the source driver, as the gate driver is enabled and a second period of time elapses thereafter.

17. The timing controller of claim 16, wherein the second period of time is about a single frame.

18. The timing controller of claim 15, wherein the data output unit includes a multiplexer having an input terminal to which the converted RGB data output from the data processing unit and a low level data for displaying black data is input, and a selection terminal to which a selection signal from the initial operation control unit is input.

19. A display device, comprising:
a display panel having a plurality of gate lines, a plurality of data lines and a plurality of pixels formed on an area defined by the gate lines and the data lines;
a gate driver configured to sequentially output a drive signal to the gate lines;
a source driver configured to output an image data signal to the data lines; and
a timing controller configured to operate a frame counter based on a synchronization signal input from an external device and to control the gate driver such that an output of the gate driver is disabled during a period of time after the display device is powered-on.

20. The display device of claim 19, wherein the timing controller includes:
a timing generator configured to generate a source driver control signal, and a gate driver control signal for controlling the source driver and the gate driver, respectively, based on the synchronization signal input from the external device;
a frame counter unit configured to operate the frame counter and wherein the display device is powered on using the frame counter; and
an initial operation control unit configured to control an output of the gate driver control signal such that the output of the gate driver is disabled during the period of time after the display device is powered-on using the frame counter.

21. The display device of claim 20, wherein the period of time is about two frames.

22. The display device of claim 20, wherein the period of time is user customizable.

23. The display device of claim 20, wherein the synchronization signal input from the external device comprises a vertical synchronization signal, a horizontal synchronization signal, a data enable signal and/or a master clock signal.

24. The display device of claim 23, wherein the frame counter unit generates an internal vertical synchronization signal based on the data enable signal input from the external device.

25. The display device of claim 24, wherein the internal vertical synchronization signal is generated when an input signal does not exist in a low level range of the data enable signal during a specified period of time.

26. The display device of claim 25, wherein the frame counter unit operates the frame counter based on the generated internal vertical synchronization signal.

27. The display device of claim 26, wherein the frame counter does not operate when the data enable signal is unstable.

28. The display device of claim 20, wherein the source driver control signal comprises a horizontal start pulse, a data latch signal and/or a polarity control signal, and wherein the source driver control signal is output to the source driver by a control signal of the initial operation control unit.

29. The display device of claim 20, wherein the gate driver control signal comprises a vertical start pulse and/or a vertical clock signal.

30. The display device of claim 20, wherein the gate driver control signal comprises a gate driver output enable signal that controls an output of the gate driver.

31. The display device of claim 30, wherein the initial operation control unit disables the gate driver output enable signal during the period of time after the display device is powered-on.

32. The display device of claim 20, wherein the timing controller further comprises a control signal output unit configured to output the source driver control signal and the gate driver control signal generated by the timing generator based on an output permission signal provided from the initial operation control unit.

33. The display device of claim 32, wherein the control signal output unit includes a plurality of logic gates that perform a logical AND operation of one of the output permission signals provided from the initial operation control unit and one of the source driver control signal and the gate driver control signal.

34. The display device of claim 20, wherein the timing controller further comprises:
a data processing unit configured receive red, green, blue (RGB) data output from an external device and convert the RGB data into a data format required by the source driver; and
a data output unit configured to output the RGB data converted by the data processing unit to the source driver under a control of the initial operation control unit.

35. The display device of claim 34, wherein the initial operation control unit controls the data output unit such that the data output unit outputs the converted RGB data to the source driver, as the gate driver is enabled and a second period of time elapses thereafter.

36. The display device of claim 35, wherein the second period of time is about a single frame.

37. A method of controlling an initial operation of a display device, comprising:
generating an internal vertical synchronization signal based on a data enable signal output from an external device when a power voltage is input;
operating a frame counter based on the internal vertical synchronization signal;
disabling an output of a gate driver until a count value of the frame counter reaches a threshold value; and
enabling the output of the gate driver after a count value of the frame counter is equal to the threshold value.

38. The method of claim 37, wherein disabling the output of the gate driver comprise controlling the gate driver and the source driver such that the gate driver and the source driver operate normally.

39. The method of claim 37, wherein the threshold value is about two frames.

40. The method of claim 37, further comprising:
outputting RGB data to the source driver after the gate driver is enabled, and a second period of time elapses thereafter.
